(19) United States
(12) Patent Application Publication
(10) Pub. No.: US 2026/0088479 A1
(43) Pub. Date: Mar. 26, 2026

(54) LOW-PASS FILTER DEVICE

(71) Applicant: KMW INC., Hwaseong-si (KR)

(72) Inventor: Joung-hoe KIM, Hwaseong-si (KR)

(73) Assignee: KMW INC., Hwaseong-si (KR)

(21) Appl. No.: 19/403,744

(22) Filed: Nov. 28, 2025

Related U.S. Application Data
(63) Continuation of application No. PCT/KR2024/006479, filed on May 13, 2024.

(30) Foreign Application Priority Data
May 31, 2023 (KR) 10-2023-0069807

(51) Int. Cl. H01P 1/20

(52) U.S. Cl. CPC H01P 1/2002

(57) ABSTRACT

According to an embodiment of the present disclosure, provided is a low-pass filter device comprising: a first port disposed on one longitudinal side; a second port disposed on the other longitudinal side; a plurality of metal members disposed spaced apart from each other between the first port and the second port; a plurality of connecting members disposed between adjacent metal members among the plurality of metal members; a first dielectric tube disposed to surround at least one of the plurality of metal members; a metal pipe disposed to surround the first dielectric tube; and a second dielectric tube disposed to surround a metal member not surrounded by the first dielectric tube, among the plurality of metal members, and the metal pipe.

### CROSS-REFERENCE TO RELATED APPLICATIONS

This application is a continuation application of International Application No. PCT/KR2024/006479, filed May 13, 2024, which claims the benefit of Korean Patent Application No. 10-2023-0069807, filed May 31, 2023 in the Korean Intellectual Property Office, the disclosures of which are incorporated herein by reference in their entirety.

### TECHNICAL FIELD

The present disclosure relates to a low-pass filter device.

### BACKGROUND ART

The content described in this section merely provides background information on the present disclosure and does not constitute prior art.

A filter is a device that blocks unwanted signals and pass only desired signals using frequency characteristics. There are several types of filters. A high pass filter (HPF) passes high-frequency signals and blocks low-frequency signals. A band pass filter (BPF) passes signals within a certain frequency bandwidth and blocks all other signals. A low-pass filter (LPF) passes low-frequency signals and blocks high-frequency signals.

FIG. 1 is a perspective view of a conventional low-pass filter.

Referring to FIG. 1, a conventional low-pass filter 1 can be manufactured by turning a round bar. The attenuation performance of the low-pass filter 1 improves as the number of inductor members 3 and the number of capacitor members 5 increase. Here, the inductor member 3 forms an inductor in the circuit diagram (not shown), and the capacitor member 5 forms a capacitor in the circuit diagram. As the number of inductor members 3 and capacitor members 5 disposed to improve the attenuation performance increases, there is a problem that the overall length of the low-pass filter 1 increases. As the length of the low-pass filter 1 increases, there is a problem that the manufacturing cost increases.

### DISCLOSURE

### Technical Problem

Accordingly, to solve such problems, a main object of the present disclosure is to provide a low-pass filter device that includes a metal pipe inside to form a notch and exhibits improved attenuation performance relative to the same length.

Furthermore, a main object of the present disclosure is to provide a low-pass filter device with a shorter length compared to other products with the same performance to reduce costs.

### Technical Solution

In order to achieve the above purpose, in accordance with one embodiment of the present disclosure, there is provided a low-pass filter device comprising: a first port disposed on one longitudinal side; a second port disposed on the other longitudinal side; a plurality of metal members disposed spaced apart from each other between the first port and the second port; a plurality of connecting members disposed between adjacent metal members among the plurality of metal members; a first dielectric tube disposed to surround at least one of the plurality of metal members; a metal pipe disposed to surround the first dielectric tube; and a second dielectric tube disposed to surround a metal member not surrounded by the first dielectric tube, among the plurality of metal members, and the metal pipe.

### Advantageous Effects

As described above, according to the present embodiment, it is possible to provide a low-pass filter device that includes a metal pipe inside to form a notch, resulting in improved attenuation performance relative to the same length.

Furthermore, it is possible to form a low-pass filter device with a shorter length compared to other products with the same performance, resulting in a cost reduction.

### DESCRIPTION OF DRAWINGS

FIG. 1 is a perspective view of a conventional low-pass filter.

FIG. 2 is a perspective view of a low-pass filter device according to an embodiment of the present disclosure.

FIG. 3 is an exploded perspective view of the low-pass filter device according to an embodiment of the present disclosure.

FIG. 4 is a cross-sectional view of the low-pass filter device according to an embodiment of the present disclosure.

FIG. 5 is a cross-sectional view taken along line A-A′ in FIG. 4.

FIG. 6 is a graph illustrating attenuation characteristics of the low-pass filter device according to an embodiment of the present disclosure.

FIG. 7 is a circuit diagram of the low-pass filter device according to an embodiment of the present disclosure.

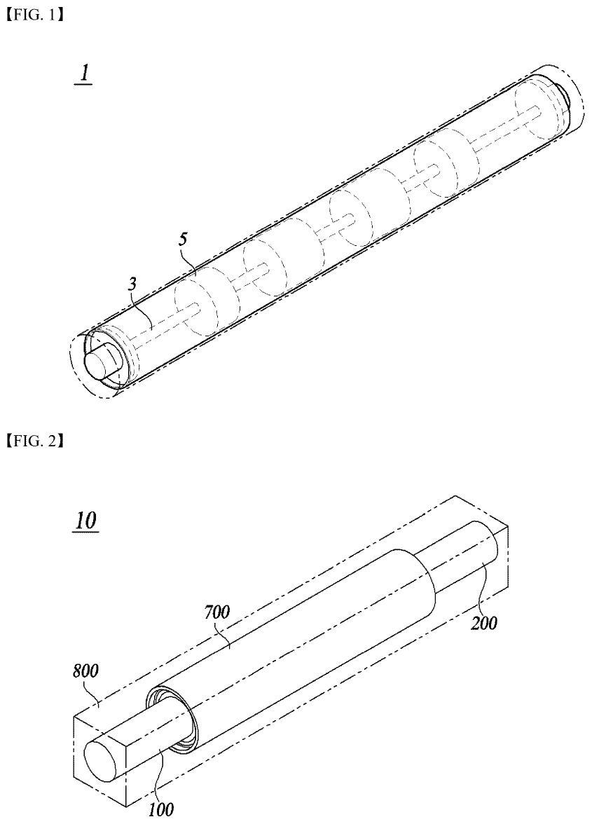

### MODE FOR INVENTION

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

In the present disclosure, the longitudinal direction refers to the x-axis direction illustrated in FIG. 4. That is, the longitudinal direction refers to the length direction of a low-pass filter device 10.

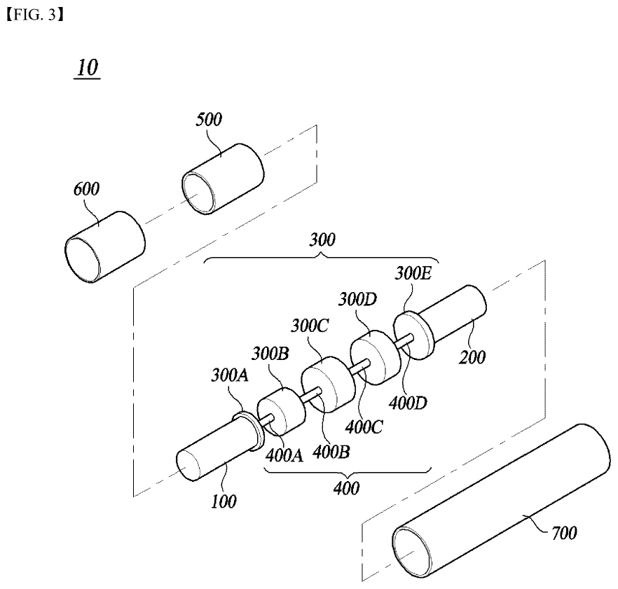

FIG. 2 is a perspective view of a low-pass filter device according to an embodiment of the present disclosure.

FIG. 3 is an exploded perspective view of the low-pass filter device according to an embodiment of the present disclosure.

FIG. 4 is a cross-sectional view of the low-pass filter device according to an embodiment of the present disclosure.

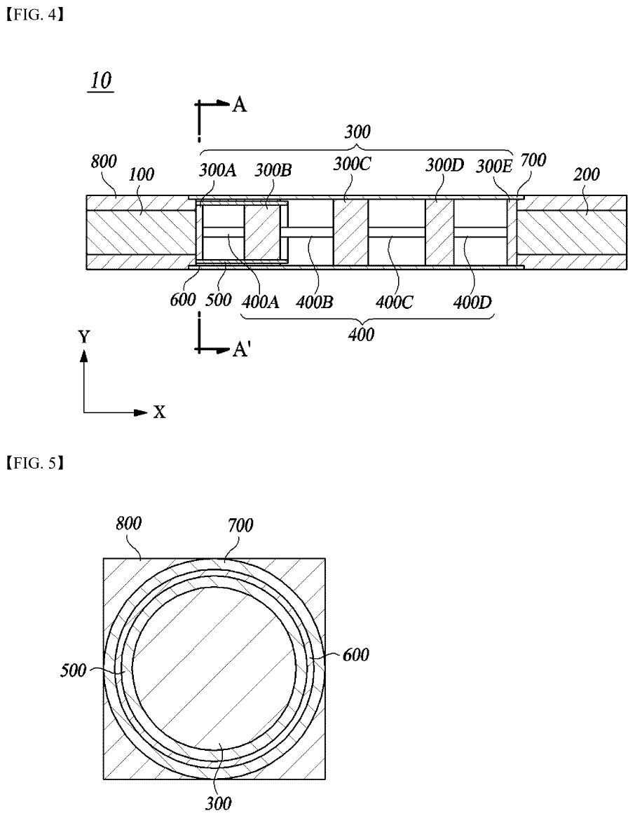

FIG. 5 is a cross-sectional view taken along line A-A′ in FIG. 4.

Referring to FIG. 2 to FIG. 5, the low-pass filter device 10 according to an embodiment of the present disclosure includes all or some of a first port 100, a second port 200, a plurality of metal members 300, a plurality of connecting members 400, a first dielectric tube 500, a metal pipe 600, a second dielectric tube 700, and a case 800.

The first port 100 is disposed on one longitudinal side. The first port 100 is electrically connected to the plurality of metal members 300. The first port 100 may transmit an input signal to the plurality of metal members 300. The first port 100 may form an inductor. In an embodiment, the first port 100 may be connected to a first metal member 300A.

The second port 200 is disposed on the other longitudinal side. The second port 200 outputs a filtered signal. The second port 200 is electrically connected to the plurality of metal members 300. The second port 200 may receive signals from the plurality of metal members 300. The second port 200 may form an inductor. In an embodiment, the second port 200 may be connected to a fifth metal member 300E. Referring to FIG. 3 and FIG. 4, the second port 200 is connected to the fifth metal member 300E, but the present disclosure is not limited thereto. For example, when the plurality of metal members 300 include three metal members, the second port 200 is connected to the third metal member 300C.

In an embodiment, the diameter of the first port 100 may be the same as the diameter of the second port 200. In an embodiment, each diameter of the first port 100 and the second port 200 may be greater than each diameter of the plurality of connecting members 400 and smaller than each diameter of the plurality of metal members 300.

The plurality of metal members 300 may be disposed between the first port 100 and the second port 200. The plurality of metal members 300 may be disposed spaced apart from each other. The plurality of metal members 300 may form a capacitor.

The plurality of metal members 300 may include a first metal member 300A to an Nth metal member. In this case, the first metal member 300A to the Nth metal member may be arranged in order of proximity to the first port 100. Here, N is a natural number equal to or greater than 2.

According to an embodiment, the plurality of metal members 300 may include the first metal member 300A to a fifth metal member 300E. Referring to FIG. 3 and FIG. 4, the plurality of metal members 300 includes the first metal member 300A to the fifth metal member 300E, but the present disclosure is not limited thereto. The plurality of metal members 300 may include more or less than five metal members.

Metal members surrounded by the first dielectric tube 500 among the plurality of metal members 300 may have the same diameter. According to an embodiment, each outer peripheral surface of the first metal member 300A and the second metal member 300B may be surrounded by the first dielectric tube 500. In this case, the first metal member 300A and the second metal member 300B may have the same diameter. In addition, the diameters of the first metal member 300A and the second metal member 300B may be smaller than the diameters of the third to fifth metal members 300E.

According to an embodiment, each of the plurality of metal members 300 may have the same length or different lengths. Here, the length of the metal member refers to the length in the longitudinal direction (X-axis in FIG. 4). According to an embodiment, the length of the second metal member 300B may be greater than the length of the first metal member 300A.

According to an embodiment, the outer circumference of a metal member that is not surrounded by the first dielectric tube 500 among the plurality of metal members 300 may be formed to be identical to the outer circumference of the metal pipe 600. According to an embodiment, the third metal member 300C to the fifth metal member 300E may not be surrounded by the first dielectric tube 500, and the first metal member 300A and the second metal member 300B may be surrounded by the first dielectric tube 500. In this case, the outer circumferences of the third metal member 300C to the fifth metal member 300E may be formed to be identical to the outer circumference of the metal pipe 600. That is, the outer circumferences of the components that are in contact with the inner circumference of the second dielectric tube 700 may all be formed to be identical. In this case, when the outer circumferences of the components are all the same, the second dielectric tube 700 can stably fasten the third metal member 300C to the fifth metal member 300E and the metal pipe 600.

The plurality of connecting members 400 may be disposed between adjacent metal members 300 among the plurality of connecting members 400. The plurality of connecting members 400 is electrically connected to the plurality of metal members 300. The plurality of connecting members 400 transmit an input signal to the plurality of metal members 300. The plurality of connecting members 400 may form an inductor. Referring to FIG. 3 and FIG. 4, the plurality of connecting members 400 may include a first connecting member 400A to a fourth connecting member 400D, but the present disclosure is not limited thereto. The plurality of connecting members 400 may include more or less than four connecting members.

The first dielectric tube 500 is disposed to surround at least one metal member among the plurality of metal members 300. The first dielectric tube 500 is disposed between the outer circumferential surfaces of the plurality of metal members 300 and the inner circumferential surface of the metal pipe 600. According to an embodiment, the first dielectric tube 500 may be disposed to surround two or more adjacent metal members among the plurality of metal members 300. According to an embodiment, the first dielectric tube 500 may be disposed to surround the first metal member 300A and the second metal member 300B.

Referring to FIG. 3 and FIG. 4, the first dielectric tube 500 surrounds the first metal member 300A and the second metal member 300B, but the present disclosure is not limited thereto. The first dielectric tube 500 may be formed to surround three or more metal members.

According to an embodiment, the first dielectric tube 500 may be manufactured using Teflon (PTFE, polytetrafluoroethylene). In an embodiment, the length of the first dielectric tube 500 may be greater than or equal to the length of the metal pipe 600. When the first dielectric tube 500 is longer than the metal pipe 600, the electrical stability of the low-pass filter device 10 is improved.

In an embodiment, the first dielectric tube 500 may be a shrink tube. A shrink tube is a tube that has the property of shrinking due to heat. A shrink tube is primarily used as an insulator for wires and cables.

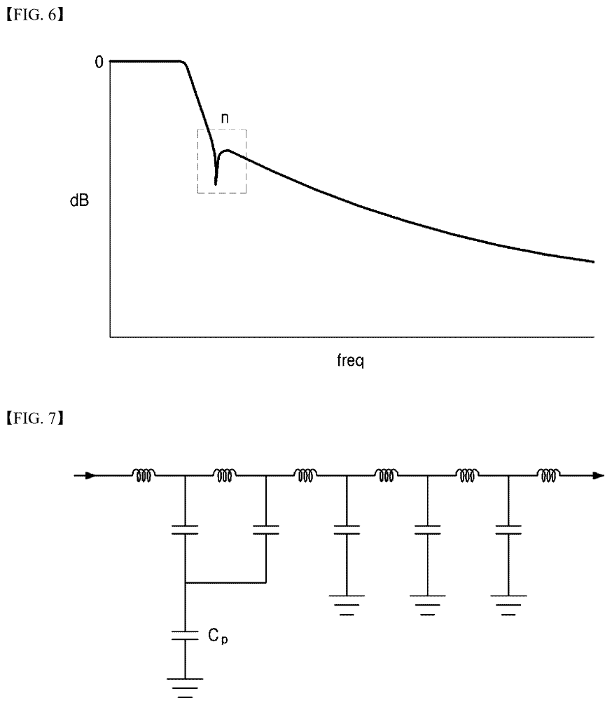

FIG. 6 is a graph illustrating the attenuation characteristics of the low-pass filter device according to an embodiment of the present disclosure.

FIG. 7 is a circuit diagram of the low-pass filter device according to an embodiment of the present disclosure.

Referring to FIG. 2 to FIG. 7, the metal pipe 600 is positioned between the first dielectric tube 500 and the second dielectric tube 700. The metal pipe 600 is disposed to surround the outer circumference of the first dielectric tube 500.

The metal pipe 600 may form a capacitor CP. The metal pipe 600 may form a notch n in the frequency response graph. The notch n improves the attenuation performance of the low-pass filter device 10.

The better the attenuation performance of the filter, the more efficient filtering is possible. Since the attenuation performance is improved by the notch n, the low-pass filter device 10 can have a shorter longitudinal length than other filters that exhibit the same performance.

According to an embodiment, the length of the low-pass filter device 10 to exhibit the same performance as a conventional filter is about 70% of the length of the conventional filter. That is, there is an effect of shortening the length of the filter by more than 30% compared to the conventional filter to exhibit the same performance. As the length of the low-pass filter device 10 is shortened, there is an effect of reducing the manufacturing cost. The number of inductors and capacitors is not limited to the number shown in FIG. 7. For example, the low-pass filter device 10 may form a circuit diagram different from the circuit diagram of FIG. 7 depending on the number of metal members 300, the length of the first dielectric tube 500, the number of first dielectric tubes 500, the length of the metal pipe 600, the number of metal pipes 600, etc.

Referring to FIG. 3 and FIG. 4, only one metal pipe 600 is disposed inside the second dielectric tube 700, but the present disclosure is not limited thereto. A plurality of metal pipes 600 may be disposed. By disposing a plurality of metal pipes 600, the attenuation performance of the filter can be improved.

Referring to FIG. 4, the length of the metal pipe 600 may be equal to the distance from the upper surface of the first metal member 300A to the bottom surface of the second metal member 300B. The upper surface of the first metal member 300A refers to one surface close to the first port 100, and the bottom surface of the second metal member 300B refers to the other surface close to the second port 200. The length of the metal pipe 600 is not limited to that shown in FIG. 4. The length of the metal pipe 600 is not limited by the arrangement of the plurality of metal members 300 or the distance between the metal members 300.

The second dielectric tube 700 is disposed inside the case 800. The second dielectric tube 700 is disposed to surround the plurality of metal members 300 and the metal pipe 600. Specifically, the second dielectric tube 700 is disposed to surround the metal members that are not surrounded by the first dielectric tube 500 among the plurality of metal members 300 and the metal pipe 600. According to an embodiment, the length of the second dielectric tube 700 may be greater than the distance from the upper surface of the first metal member 300A to the bottom surface of the fifth metal member 300E. In this case, the second dielectric tube 700 stably fastens the components disposed therein and improves the electrical stability of the low-pass filter device 10.

According to an embodiment, the second dielectric tube 700 may be formed to surround the metal pipe 600, the third metal member 300C, the fourth metal member 300D, and the fifth metal member 300E. In this case, the outer circumference of the metal pipe 600 and the outer circumferences of the third metal member 300C, the fourth metal member 300D, and the fifth metal member 300E may be formed to be the same. Referring to FIG. 3, the second dielectric tube 700 surrounds the third metal member 300C to the fifth metal member 300E and the metal pipe 600, but the present disclosure is not limited thereto. The number of metal members surrounded by the second dielectric tube 700 may vary depending on the number of metal members disposed between the first port 100 and the second port 200. Depending on the number of metal members surrounded by the metal pipe 600, the number of metal members surrounded by the second dielectric tube 700 may vary.

The second dielectric tube 700 prevents current leakage or noise generation between adjacent components. The second dielectric tube 700 provides a stable electrical environment, assists the operation of the low-pass filter device 10, and improves the filtering efficiency of the low-pass filter device 10. According to an embodiment, the second dielectric tube 700 may be manufactured using Teflon. The second dielectric tube 700 may be a shrink tube.

The case 800 forms an internal accommodating space. The case 800 is formed to surround the second dielectric tube 700, the first port 100, and the second port 200. The case 800 improves the durability and electrical stability of the low-pass filter device 10. Referring to FIG. 2 and FIG. 5, the cross section of the case 800 is illustrated as a rectangular section including a hole in the center, but the present disclosure is not limited thereto. The cross section of the case 800 may have various shapes.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

### DESCRIPTION OF REFERENCE NUMERALS

10: low-pass filter device
100: first port
200: second port
300: plurality of metal members
400: plurality of connecting members
500: first dielectric tube
600: metal pipe
700: second dielectric tube
800: case

1. A low-pass filter device comprising:
a first port disposed on one longitudinal side;
a second port disposed on the other longitudinal side;
a plurality of metal members disposed spaced apart from each other between the first port and the second port;
a plurality of connecting members disposed between adjacent metal members among the plurality of metal members;
a first dielectric tube disposed to surround at least one of the plurality of metal members;
a metal pipe disposed to surround the first dielectric tube; and
a second dielectric tube disposed to surround a metal member not surrounded by the first dielectric tube, among the plurality of metal members, and the metal pipe.

2. The low-pass filter device of claim 1, wherein the plurality of metal members include a first metal member to an Nth metal member,
wherein the first metal member is disposed closest to the first port, and the Nth metal member is disposed farthest from the first port,
wherein N is a natural number equal to or greater than 2.

3. The low-pass filter device of claim 1, wherein the first dielectric tube is disposed to surround two or more adjacent metal members among the plurality of metal members.

4. The low-pass filter device of claim 2, wherein the first dielectric tube is disposed to surround the first metal member and the second metal member.

5. The low-pass filter device of claim 1, wherein each of the plurality of metal members has a different length.

6. The low-pass filter device of claim 2, wherein a length of the second metal member is greater than a length of the first metal member.

7. The low-pass filter device of claim 1, wherein metal members surrounded by the first dielectric tube, among the plurality of metal members, have the same diameter.

8. The low-pass filter device of claim 2, wherein the first metal member and the second metal member have the same diameter.

9. The low-pass filter device of claim 1, wherein an outer circumference each of at least one metal members not surrounded by the first dielectric tube, among the plurality of metal members, is identical to an outer circumference of the metal pipe.

10. The low-pass filter device of claim 2, wherein the first metal member and the second metal member are surrounded by the first dielectric tube, the third to fifth metal members are not surrounded by the first dielectric tube, and an outer circumferences of each of the third to fifth metal members are identical to an outer circumference of the metal pipe.

11. The low-pass filter device of claim 1, wherein a length of the first dielectric tube is equal to or greater than a length of the metal pipe.

12. The low-pass filter device of claim 1, wherein the metal pipe forms a capacitor.

13. The low-pass filter device of claim 1, wherein the metal pipe forms a notch to improve attenuation performance.

14. The low-pass filter device of claim 1, further comprising a case formed to surround the second dielectric tube, the first port, and the second port.

15. The low-pass filter device of claim 1, wherein the first port and the second port have the same diameter.

16. The low-pass filter device of claim 1, wherein each diameter of the first port and the second port is less than each diameter of plurality of the metal members and greater than each diameter of the plurality of connecting members.

17. The low-pass filter device of claim 1, wherein at least one of the first dielectric tube and the second dielectric tube is manufactured using Teflon.

18. The low-pass filter device of claim 1, wherein at least one of the first dielectric tube and the second dielectric tube is a shrink tube shrinking by heat.

19. The low-pass filter device of claim 2, wherein a length of the metal pipe is equal to a distance from an upper surface of the first metal member to a bottom surface of the second metal member.

20. The low-pass filter device of claim 2, wherein a length of the second dielectric pipe is greater than a distance from an upper surface of the first metal member to a bottom surface of the fifth metal member.
